(19) United States
(12) Patent Application Publication
(10) Pub. No.: US 2016/0308378 A1
(43) Pub. Date: Oct. 20, 2016

(54) SPEEDILY-CHARGING MOBILE POWER

(71) Applicant: Shenzhen Mass Power Electronic Limited, Shenzhen City (CN)

(72) Inventor: Zhong Wei, Shenzhen City (CN)

(21) Appl. No.: 14/794,068

(22) Filed: Jul. 8, 2015

(30) Foreign Application Priority Data
Apr. 14, 2015 (CN) 201510172919.3

(51) Int. Cl. H02J 7/00

(52) U.S. Cl. CPC H02J 7/0034; H02J 7/0072; H02J 2007/0037; H02J 2007/0039

(57) ABSTRACT

A speedily-charging mobile power includes a lithium titanate battery mounted in a battery protection board, a charging circuit adapted to charge the lithium titanate battery, an output circuit outputting an electric energy of the lithium titanate battery for speedily charging an electronic product, and an MCU adapted to control a charging and discharging operation. A battery voltage divider resistor is disposed on the battery protection board. Thus, the mobile power can charge speedily and have high safety performance and high transformation efficiency.

### BACKGROUND OF THE INVENTION

1. Field of the Invention

This invention relates to a mobile power and relates particularly to a speedily-charging mobile power.

2. Description of the Related Art

Generally, traditional mobile powers store energy by using lithium-ion batteries which uses the rate of 1 C. To obtain a charging and discharging operation, the operation reduces the voltage of 5V for charging and provides an output voltage to attain a boost or step-up mode which increases the voltage.

A prior art published by the China Patent no. 201210071774.4 discloses a mobile power which includes a storage battery, a charge control circuit, a cell protection circuit, an MCU control circuit and a DC-DC boost circuit. The charge control circuit has an input end connected to an exterior power. An output end of the charge control circuit is electrically connected to an input end of the cell protection circuit. The storage battery is electrically connected to the cell protection circuit. The cell protection circuit is electrically connected to the DC-DC boost circuit. The MCU control circuit is electrically connected to the DC-DC boost circuit. The mobile power further includes an automatic identification circuit capable of identifying received load devices. The automatic identification circuit is electrically connected to the MCU control circuit. The disclosed mobile power uses the DC-DC boost circuit to discharge the electricity to the outside.

However, when the electric energy of the storage battery has an increase in the voltage, the energy consumption inevitably comes out and causes the low transformation efficiency of the electric energy.

### SUMMARY OF THE INVENTION

A primary object of this invention is to solve the aforementioned problem and to provide a mobile charging power which charges quickly and has high safety performance and high transformation efficiency.

The speedily-charging mobile power of this invention includes a lithium titanate battery mounted in a battery protection board, a charging circuit adapted to charge the lithium titanate battery, an output circuit outputting an electric energy of the lithium titanate battery for speedily charging an electronic product, and an MCU adapted to control a charging and discharging operation. The charging circuit and the output circuit are all connected to the battery protection board. A battery protection circuit and a battery voltage divider resistor are disposed on the battery protection board and adapted to the lithium titanate battery. The battery protection circuit and the battery voltage divider resistor are all connected to the lithium titanate battery. The battery voltage divider resistor is constructed by a pull-down resistor R9 which loads on a voltage detection end WD01+VDD of a circuit of the battery protection board, thereby making a voltage at a FB point on the circuit correspondent with a standard value of the lithium titanate battery.

Preferably, the lithium titanate battery of the battery protection board is a battery set with a voltage of 4.6V˜5.6V formed by two series-connected lithium titanate batteries of a rate of 6C and the electric energy of 2.3V˜2.8V.

Preferably, the battery protection circuit includes two parallel-connected 8025 chips which are set back to back.

Preferably, the charging circuit includes an overcharge protection circuit, an over-voltage protection circuit and a reverse intrusion protection circuit disposed thereon.

Preferably, the over-voltage protection circuit is formed by two 4435 chips to prevent a direct communication of a voltage.

Preferably, the reverse intrusion protection circuit is constructed by two 3904 MOS tubes. Preferably, the output circuit has a USB port and a USB current-limiting protection circuit connected to the USB port.

Preferably, the USB current-limiting protection circuit is formed by a TD9517 chip. By comparison with the aforementioned prior art, this invention has obvious advantages and beneficial effects. From above, the mobile power of this invention, specifically, uses the lithium titanate battery as a cell and simultaneously arranges an adaptive battery voltage divider resistor on the battery protection board for the lithium titanate battery, thereby offering the protection. In view of the character of the lithium titanate battery, the circuit layout can omit a buck (step-down) charging and boost (step-up) discharging operation, and the this invention can reduce the charging time by 80% in comparison with the charging time of the traditional mobile power with the same capacity and fulfill the transformation of the output discharge efficiency up to 98%˜100%. Therefore, the mobile charging power of this invention charges quickly and has high safety and high transformation efficiency whereby electronic products, such as cellular phones and iPads, are quickly charged within 5 to 8 minutes. This invention can overcome problems of the traditional mobile power, namely the long charging time, the large consumption of the electric energy transformation and the low safety performance of the product.

The features and advantages of this invention are more apparent upon reading following preferred embodiments in conjunction with accompanying drawings.

### BRIEF DESCRIPTION OF THE DRAWINGS

FIG. 1 is a block diagram showing a concatenation of elements of a preferred embodiment of this invention; and

FIG. 2 is a schematic diagram view showing a circuit of the battery protection board of the preferred embodiment of this invention.

### DETAILED DESCRIPTION OF THE PREFERRED EMBODIMENTS

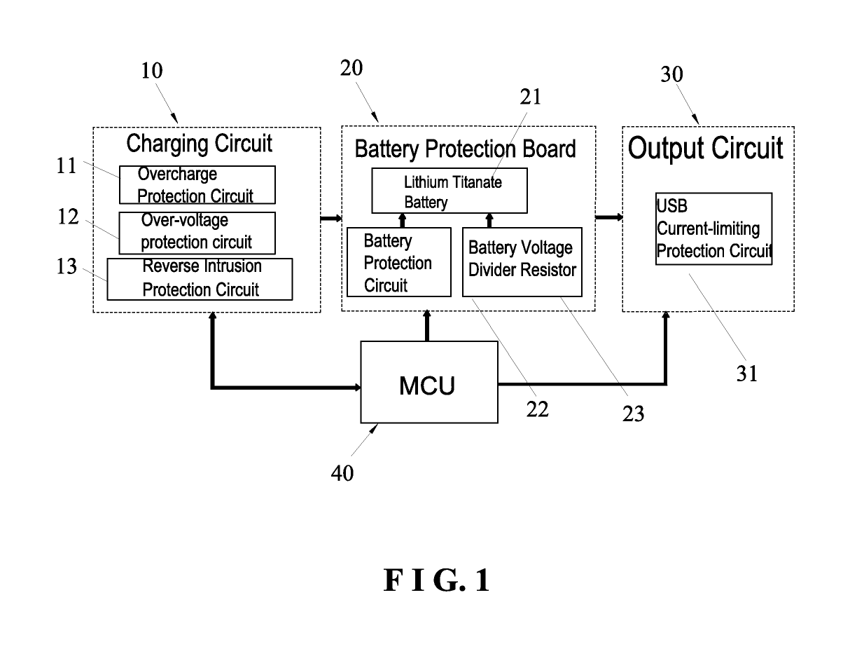

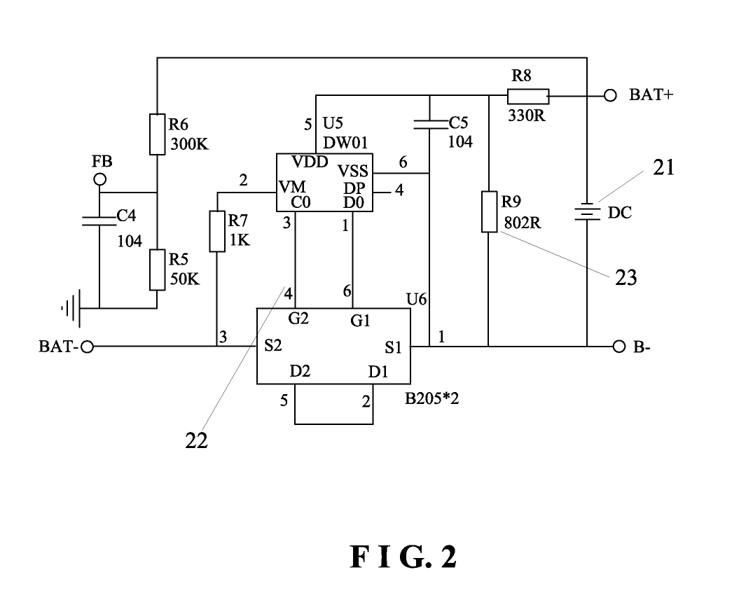

Referring to FIG. 1 and FIG. 2, a speedily-charging mobile power of the preferred embodiment of this invention includes a charging circuit 10, a battery protection board 20, an output circuit 30 and an MCU 40. The charging circuit 10 is electrically connected to a power input end of the battery protection board 20 to fulfill the function of charging a lithium titanate battery 21. The output circuit 30 is electrically connected to a power output end of the battery protection board 20 to output an electric energy of the lithium titanate battery 21 for speedily charging an electronic product. The MCU 40 is electrically connected to the charging circuit 10, the battery protection board 20 and the output circuit 30 to instantly detect a change in the voltage of the lithium titanate battery 21 and control a charging and discharging operation for a safe charging mode.

The battery protection board 20 includes a lithium titanate battery 21, a battery protection circuit 22 and a battery voltage divider resistor 23 disposed thereon. The battery protection circuit 22 and the battery voltage divider resistor 23 are adapted to the lithium titanate battery 21. The lithium titanate battery 21, serving as a cell to store energy, is defined by connecting two lithium titanate batteries of a rate of 6C and an electric energy of 2.3V˜2.8V in series to form a battery set with a voltage of 4.6V˜5.6V, and the strongest energy is 4.8V˜5.2V. By this character, when the lithium titanate battery 21 is charged, a direct mutual charging effect is obtained without reducing the voltage, and the zero consumption is attained. The discharge of the lithium titanate battery 21 can directly charge the load without increasing the voltage, thereby attaining the electric energy transformation up to 100%.

The traditional lithium titanate battery in the market does not have an adequate protection IC. For the lithium titanate battery 21, this invention provides the battery protection circuit 22 and the battery voltage divider resistor 23 which are disposed on the battery protection board 21.

The battery protection circuit 22 uses two parallel-connected 8025 chips whose backs abut with each other. The battery voltage divider resistor 23, constructed by a pull-down resistor R9 having a nominal resistance of 820R, pulls down one percent (1%) of the 820R resistance at a voltage detection end WD01+and a VDD pin of the battery protection IC (e.g. 8025 chip) of the battery protection board 20, thereby adapting the voltage of series-connected lithium titanate batteries to the protection IC (e.g. 8025 chip) of the traditional lithium battery and allowing a voltage of a FB point on the circuit to correspond with a standard value of the lithium titanate batteries 21. Thus, the effect of protection is obtained.

This invention provides the charging circuit 10 with a constant current and constant voltage design to ensure that the charging current is stable at a predetermined threshold when the product is directly and mutually charged. The direct charging operation can reduce the transformation consumption of energy incurred by the traditional buck mode which reduces the voltage. The consumption of electric energy almost reaches to zero and the MCU 40 detects the change in the voltage of the battery instantly to make sure that the charging operation is safe enough. In this preferred embodiment, the charging circuit 10 is electrically connected to a charging end of the lithium titanate battery 21. The charging circuit 10 includes an overcharge protection circuit 11, an over-voltage protection circuit 12 and a reverse intrusion protection circuit 13 disposed thereon. The over-voltage protection circuit 13 is formed by two 4435 chips to prevent a direct communication of the voltage. The reverse intrusion protection circuit 13 is constructed by two 3904 MOS tubes to prevent the problem of intrusions. The overcharge protection circuit 11 can shut off the electricity automatically when the lithium titanate battery 21 is full. This invention takes advantage of this charging circuit 10 to break through the traditional buck charge mode. This invention can charge directly and charge quickly with large currents, thereby preventing the consumption of electric energy deriving from the traditional buck charge mode.

The output circuit 30 of this invention is electrically connected to a discharging end of the lithium titanate battery 21. The output circuit 30 has a USB port and a USB current-limiting protection circuit 31 connected to the USB port. The USB current-limiting protection circuit 31 is formed by a TD9517 chip. When a product discharges electricity to the outside, the voltage of the lithium titanate battery 21 at about 5.2V can directly charge cellular phones or other electronic devices without adding boost circuits. The configuration, using two sections of lithium titanate batteries connected in series to discharge the electronic device directly, can fulfill a direct communication for a mutual charging operation, reduce the consumption of electric energy caused by traditional boost mode, and attain the electric energy transformation efficiency up to 98%˜100%.

To sum up, the feature of this invention is to provide the mobile power where the lithium titanate battery 21 is used as a cell and an adaptive battery voltage divider resistor 23 is simultaneously arranged on the battery protection board 20 for the lithium titanate battery 21 in order to offer the protection. In view of the character of the lithium titanate battery 21, the circuit layout can omit the step of charging by reducing the voltage and the step of discharging by increasing the voltage. Accordingly, this invention reduces the charging time by 80% in comparison with the charging time of the traditional mobile power with the same capacity and fulfills the transformation of the output discharging efficiency up to 98%˜100%. Therefore, the mobile charging power of this invention charges quickly and has high safety performance and high electric energy transformation efficiency whereby electronic products, such as phones and iPads, are quickly charged within 5 to 8 minutes. This invention can solve the problems of the traditional mobile power, namely the long charging time, the large consumption of the electric energy transformation and the low safety performance of the product.

While the embodiment of this invention is shown and described, it is understood that further variations and modifications may be made without departing from the scope of this invention.

What is claimed is:

1. A speedily-charging mobile power comprising a lithium titanate battery mounted in a battery protection board, a charging circuit adapted to charge said lithium titanate battery, an output circuit outputting an electric energy of said lithium titanate battery for speedily charging an electronic product, and an MCU adapted to control a charging and discharging operation, said charging circuit and said output circuit being connected to said battery protection board, said battery protection board including a battery protection circuit and a battery voltage divider resistor disposed thereon for being adapted to said lithium titanate battery, said battery protection circuit and said battery voltage divider resistor being connected to said lithium titanate battery, said battery voltage divider resistor being constructed by a pull-down resistor R9 which loads on a voltage detection end WD01+VDD of a circuit of said battery protection board, thereby making a voltage at a 113 point on said circuit correspondent with a standard value of said lithium titanate battery.

2. The speedily-charging mobile power as claimed in claim 1, wherein said lithium titanate battery of said battery protection board is a battery set with a voltage of 4.6V˜5.6V formed by two series-connected lithium titanate batteries of a rate of 6C and said electric energy of 2.3V˜2.8V.

3. The speedily-charging mobile power as claimed in claim 1, wherein said battery protection circuit includes two parallel-connected 8025 chips which are set back to back.

4. The speedily-charging mobile power as claimed in claim 1, wherein said charging circuit includes an overcharge protection circuit, an over-voltage protection circuit and a reverse intrusion protection circuit disposed thereon.

5. The speedily-charging mobile power as claimed in claim 4, wherein said over-voltage protection circuit is formed by two 4435 chips to prevent a direct communication of a voltage.

6. The speedily-charging mobile power as claimed in claim 4, wherein said reverse intrusion protection circuit is constructed by two 3904 MOS tubes.

7. The speedily-charging mobile power as claimed in claim 1, wherein said output circuit has a USB port and a USB current-limiting protection circuit connected to said USB port.

8. The speedily-charging mobile power as claimed in claim 7, wherein said USB current-limiting protection circuit is formed by a TD9517 chip.
